(19) United States
(12) Patent Application Publication
(10) Pub. No.: US 2021/0109308 A1
(43) Pub. Date: Apr. 15, 2021

(54) LENS ASSEMBLY

(71) Applicant: Samsung Electro-Mechanics Co., Ltd., Suwon-si (KR)

(72) Inventors: In Do SEO, Suwon-si (KR); Ju Sung PARK, Suwon-si (KR)

(73) Assignee: Samsung Electro-Mechanics Co., Ltd., Suwon-si (KR)

(21) Appl. No.: 16/783,394

(22) Filed: Feb. 6, 2020

(30) Foreign Application Priority Data
Oct. 15, 2019 (KR) 10-2019-0127854

(51) Int. Cl. G02B 7/02; G03B 17/12

(52) U.S. Cl. CPC G02B 7/021; G02B 7/022; G02B 7/025; G03B 17/12

(57) ABSTRACT

A lens assembly includes a plurality of lenses including a first lens group and a second lens group disposed on an optical axis, and a lens barrel accommodating the first and second lens groups. The first and second lens groups are fixed to the lens barrel in different manners. The first lens group includes a plurality of lenses aligned by uneven portions of ribs of the lenses in contact with each other, and a first bonding portion is disposed between the lens barrel and a lens of the first lens group disposed closest to the second lens group.

### CROSS-REFERENCE TO RELATED APPLICATIONS

This application claims the benefit under 35 U.S.C. 119(a) of Korean Patent Application No. 10-2019-0127854 filed on Oct. 15, 2019, in the Korean Intellectual Property Office, the entire disclosure of which is incorporated herein by reference for all purposes.

### BACKGROUND

### 1. Field

The present disclosure relates to a lens assembly.

### 2. Description of the Background

Recently, camera modules have become widely used in portable electronic devices such as smart phones.

Such camera modules may include lens assemblies including a plurality of lenses. In this regard, a recent trend has been to increase the number of lenses to improve performance of the camera module and decrease a size of the camera module.

As the size of camera modules has decreased, while the number of lenses has increased, it has become more difficult to align optical axes between lenses of a plurality of lenses.

In the assembly and use of camera modules, positions of lenses of a plurality of lenses may be shifted due to various factors, for example, heat, shock, or the like, thereby making it difficult to align the optical axes between the lenses.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a lens assembly includes a plurality of lenses including a first lens group and a second lens group disposed on an optical axis, and a lens barrel accommodating the first and second lens groups, wherein the first and second lens groups are fixed to the lens barrel in different manners, wherein the first lens group includes a plurality of lenses aligned by uneven portions of ribs of the lenses in contact with each other, and wherein a first bonding portion is disposed between the lens barrel and a lens of the first lens group disposed closest to the second lens group.

The first bonding portion may include a first bonding groove disposed in the lens barrel, the lens disposed closest to the second lens group, or the lens barrel and the lens disposed closest to the second lens group, and an adhesive disposed in the first bonding groove.

A spacer may be disposed between the first and second lens groups, and the adhesive may be disposed in a space surrounded by the spacer and the first bonding groove.

A plurality of the first bonding portions may be spaced apart along a circumferential direction of the lens barrel.

The plurality of the first bonding portions may be spaced apart by 90°.

The second lens group may include a plurality of lenses fitted into the lens barrel.

A second bonding portion may be disposed between the lens barrel and a lens, among a plurality of lenses disposed in the second lens group, disposed farthest from the first lens group.

The second bonding portion may include a second bonding groove disposed in the lens barrel, the lens disposed farthest from the first lens group, or the lens barrel and the lens disposed farthest from the first lens group, and an adhesive disposed in the second bonding groove.

The second bonding portion may further include a third bonding groove extending toward an optical axis from the second bonding groove.

A plurality of the second bonding portions may be spaced apart along a circumferential direction of the lens barrel.

A plurality of the first bonding portions may be spaced apart in the circumferential direction of the lens barrel, and the first and second bonding portions may be disposed to be displaced in the circumferential direction from each other when viewed in an optical axis direction.

In another general aspect, a lens assembly includes a plurality of lenses including a first lens group and a second lens group disposed on an optical axis, a spacer disposed between the first and second lens groups, and a lens barrel accommodating the first and second lens groups, wherein the first and second lens groups are fixed to the lens barrel in different manners, and wherein a first bonding portion is disposed between the spacer and the lens barrel.

The first bonding portion may include a bonding groove disposed in the spacer and an adhesive disposed in the bonding groove.

The adhesive may be disposed in a space surrounded by the first lens group, the second lens group, the spacer, and the lens barrel.

A second bonding portion may be disposed between the lens barrel and a lens, among a plurality of lenses of the second lens group, disposed farthest from the first lens group.

A plurality of lenses of the first lens group may be aligned with an uneven portion of a rib of each lens in contact with each other, and a plurality of lenses of the second lens group may be fitted into the lens barrel.

In another general aspect, a lens assembly includes a first lens disposed in a lens barrel on an optical axis, a first bonding portion disposed to fix the first lens to the lens barrel and including a bonding groove in one or more of the lens and the lens barrel, and an adhesive disposed in the groove, wherein the adhesive is sealed in the bonding groove, and a second lens disposed in the lens barrel on the optical axis and on the first lens, and fixed to the lens barrel in a different manner than the first lens.

The lens assembly may further include one or more lenses disposed on the optical axis and the first lens, and opposite the second lens, between the first lens and the second lens, or opposite the second lens and between the first lens and the second lens.

The one or more lenses may be disposed opposite the second lens and between the first lens and the second lens, the first lens and the one or more lenses disposed opposite the second lens may be aligned with an uneven portion of a rib of each lens in contact with an adjacent lens, and the second lens and the one or more lenses disposed between the first lens and the second lens may be fitted into the lens barrel.

The lens assembly may further include a spacer disposed between the first lens and the second lens, wherein the adhesive may be sealed in the bonding groove by the spacer.

Other features and aspects will be apparent from the following detailed description, the drawings, and the claims.

### BRIEF DESCRIPTION OF DRAWINGS

FIG. 1 is a schematic cross-sectional view of one or more examples of a lens assembly according to an embodiment of the present disclosure.

FIG. 2 is an enlarged view of portion “A” of FIG. 1.

FIG. 3 is a planar cross-sectional view taken along line I-I′ of FIG. 1.

FIG. 4 is an enlarged view of portion “B” of FIG. 1.

FIG. 5 is a planar cross-sectional view taken along line II-II′ of FIG. 1.

FIG. 6 is a schematic cross-sectional view of one or more examples of a lens assembly according to another embodiment.

FIG. 7 is an enlarged view of portion “C” of FIG. 6.

FIG. 8 is a planar cross-sectional view taken along line I-I′ of FIG. 6.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure. Hereinafter, while embodiments of the present disclosure will be described in detail with reference to the accompanying drawings, it is noted that examples are not limited to the same.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. As used herein “portion” of an element may include the whole element or less than the whole element.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may be also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of this disclosure. Further, although the examples described herein have a variety of configurations, other configurations are possible as will be apparent after an understanding of this disclosure.

Herein, it is noted that use of the term “may” with respect to an example, for example, as to what an example may include or implement, means that at least one example exists in which such a feature is included or implemented while all examples are not limited thereto.

An aspect of the present disclosure may provide a lens assembly capable of aligning optical axes of a plurality of lenses and preventing positions of a plurality of the lenses from being distorted.

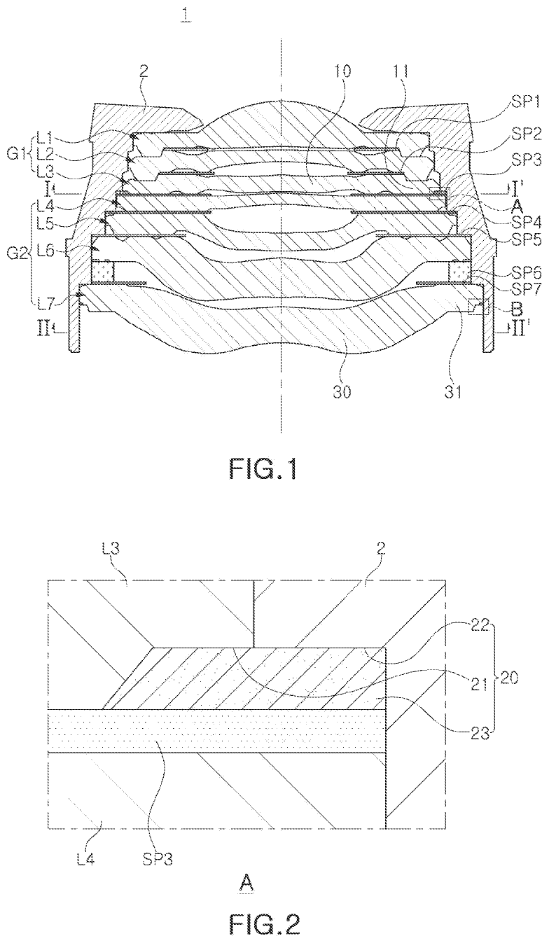

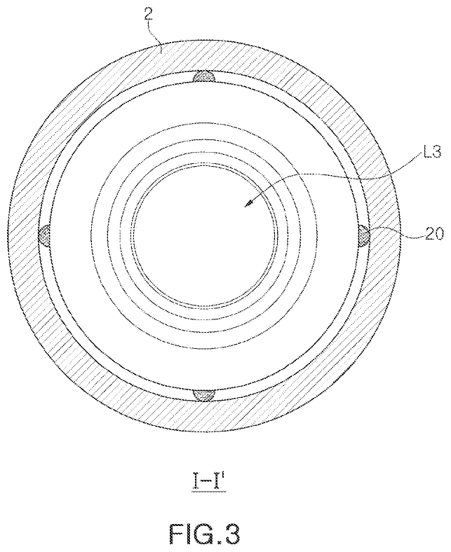

FIG. 1 is a schematic cross-sectional view of one or more examples of a lens assembly according to an embodiment of the present disclosure and FIG. 2 is an enlarged view of portion “A” of FIG. 1, while FIG. 3 is a planar cross-sectional view taken along line I-I′ of FIG. 1.

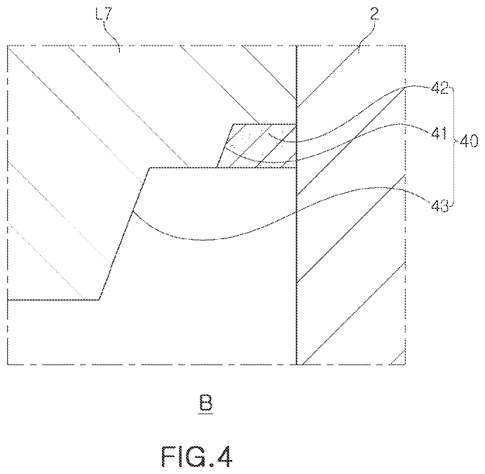

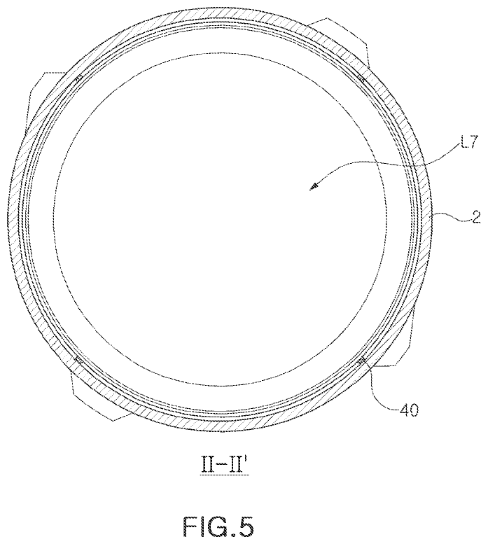

Further, FIG. 4 is an enlarged view of portion “B” of FIG. 1 and FIG. 5 is a planar cross-sectional view taken along line II-II′ of FIG. 1.

Referring to FIGS. 1 to 3, a lens assembly 1 according to an embodiment in the present disclosure includes a first lens group G1 and a second lens group G2, and further includes a lens barrel 2 accommodating the first and second lens groups G1 and G2.

The first and second lens groups G1 and G2 are disposed in order on an optical axis from an object (or a subject). For example, the first lens group G1 may be disposed closer to the object (or the subject) than the second lens group G2.

The first and second lens groups G1 and G2 each include a plurality of lenses disposed on the optical axis. The plurality of the lenses may be spaced apart by a pre-determined distance on the optical axis.

The first lens group G1 may include a first lens L1, a second lens L2 and a third lens L3, while the second lens group G2 may include a fourth lens L4, a fifth lens L5, a sixth lens L6 and a seventh lens L7. However, the present disclosure is not limited to numbers of the lenses included in the lens groups.

Among a plurality of the lenses of the first lens group G1, the first lens L1 refers to a lens closest to the object and the third lens L3 refers to a lens closest to the second lens group.

Each of a plurality of the lenses of the first lens group G1 includes an optical portion 10 and a rib 11. The optical portion 10 may be a part for optical performance of the lens. For example, light reflected from the object (or the subject) may be refracted while passing through the optical portion 10.

The rib 11 may extend at a circumference of the optical portion 10, and may be formed integrally with the optical portion 10.

The rib 11 may be an element fixing the lens to another element, for example, another lens.

Among a plurality of the lenses of the second lens group G2, the fourth lens L4 refers to a lens closest to the first lens group G1, and the seventh lens L7 refers to a lens farthest from the first lens group G1.

Each of a plurality of the lenses of the second lens group G2 includes an optical portion 30 and a rib 31. The optical portion 30 may be a part for optical performance of the lens. For example, light reflected from the object (or the subject) may be refracted while passing through the optical portion 30.

The rib 31 may extend at a circumference of the optical portion 30, and may be formed integrally with the optical portion 30.

The rib 31 may be an element fixing the lens to another element, for example, another lens.

A spacer may each be provided between neighboring lenses. At least a portion of the rib of each lens may be in contact with the spacer. The spacer can maintain an interval between the lenses and block unnecessary light.

The spacer may include a light-absorbing layer so as to block unnecessary light. The light-absorbing layer may be a black film or a black iron oxide.

The spacers may include a first spacer SP1, a second spacer SP2, a third spacer SP3, a fourth spacer SP4, a fifth spacer SPS, a sixth spacer SP6 and a seventh spacer SP7 arranged toward an image sensor from the object.

The first spacer SP1 may be disposed between the first lens L1 and the second lens L2, and the second spacer SP2 may be disposed between the second lens L2 and the third lens L3. The third spacer SP3 may be disposed between the third lens L3 and the fourth lens L4, and the fourth spacer SP4 may be disposed between the fourth lens L4 and the fifth lens L5. The fifth spacer SP5 may be disposed between the fifth lens L5 and the sixth lens L6, and the sixth spacer SP6 may be disposed between the sixth lens L6 and the seventh lens L7. The seventh spacer SP7 may also be disposed between the sixth lens L6 and the seventh lens L7.

The sixth spacer SP6 may be formed to have a largest thickness among the spacers. For example, a thickness of the sixth spacer SP6 in the optical axis direction may be larger than those of the other spacers in the optical axis direction.

The first lens group G1 and the second lens group G2 are configured to be fixed to the lens barrel 2 in different manners.

As an example, a plurality of the lenses provided in the first lens group are disposed by uneven portions of ribs of the lens in contact with each other so that the optical axes are aligned. That is, the lenses of the first lens group G1 are interconnected to fix positions thereof relative to the lens barrels.

A plurality of the lenses of the second lens group G2 may be fitted into the lens barrel 2. As an example, the ribs of the lenses of the second lens group G2 are in contact with an internal surface of the lens barrel 2 so that relative positions thereof to the lens barrel 2 may be fixed.

Meanwhile, among the lenses of the first lens group G1, the lens disposed closest to the second lens group G2 (hereinafter, the third lens L3) may be fixed to the lens barrel 2 in a different manner from the remaining lenses of the first lens group G1.

The lenses of the first lens group G1 are interconnected to fix the positions thereof relative to the lens barrel. In this case, the positions of the lenses of the first lens group G1 may be distorted by undesired factors, for example, heat, shock, or the like.

Accordingly, the positions of the remaining lenses of the first lens group G1 may be fixed by fixing the position of the third lens L3, the last lens of the lenses of the first lens group G1.

Based on FIGS. 1 and 2, a first bonding portion 20 is provided between the third lens L3 and the lens barrel 2.

The first bonding portion 20 includes first bonding grooves 21 and 22 provided in at least one of the lens barrel 2 and the third lens L3 and an adhesive 23 provided in the first bonding grooves 21 and 22.

In an example of the present embodiment illustrated in FIG. 2, the first bonding grooves 21 and 22 are provided in the third lens L3 and the lens barrel 2, but are not limited thereto. The first bonding grooves 21 and 22 may be formed in the third lens L3, the lens barrel 2, or the third lens L3 and the lens barrel 2.

The spacer (e.g., the third spacer SP3) may be disposed between the first lens group G1 and the second lens group G2, and the adhesive 23 may be provided in a space surrounded by the first bonding grooves 21 and 23 and the third spacer SP3.

In other words, as the first bonding grooves 21 and 22 are sealed by the third lens L3 and/or the lens barrel 2 and the third spacer SP3, the adhesive 23 can be prevented from leaking.

The first bonding portion 20 may include a plurality of first bonding portions 20 spaced apart along a circumferential direction of the lens barrel 2. As an example, as illustrated in FIG. 3, four first bonding portions 20 may be provided, and the four first bonding portions 20 may be spaced apart by 90°.

Referring to the examples shown in FIGS. 4 and 5, among the lenses of the second lens group G2, the lens disposed farthest from the first lens group G1 (hereinafter, the seventh lens L7) may be fixed to the lens barrel 2 in a different manner from the remaining lenses of the second lens group G2.

The ribs of the lenses of the second lens group G1 are in contact with the internal surface of the lens barrel 2 so that the positions thereof are fixed relative to the lens barrel 2. In this case, the positions of the lenses of the second lens group G2 may be distorted by undesired factors, for example, heat, shock, or the like.

Accordingly, the positions of the remaining lenses of the second lens group G2 may not be distorted by fixing the position of the seventh lens L7, the last lens of the lenses of the second lens group G2.

A second bonding portion 40 is provided between the seventh lens L7 and the lens barrel 2.

The second bonding portion 40 includes a second bonding groove 41 provided in at least one of the seventh lens L7 and the lens barrel 2 and an adhesive 42 provided in the second bonding groove 41.

As no additional spacers, press-fit rigs, or the like, are provided behind the seventh lens L7 (an image sensor-side), a configuration for preventing the adhesive 42 from leaking is necessary.

Accordingly, in an embodiment, the second bonding portion 40 may further include a third bonding groove 43 extending toward the optical axis from the second bonding groove 41.

The third bonding groove 43 can provide a space capable of accommodating the adhesive 42 which may leak when an amount thereof is large, and function as a barrier so that the adhesive 42 does not flow into the optical portion of the lens.

A plurality of the second bonding portions 40 may be spaced apart in the circumferential direction of the lens barrel 2. As an example, as illustrated in FIG. 5, four second bonding portions 40 may be provided, and the four second bonding portions 40 may be spaced apart by 90°.

Meanwhile, based on FIGS. 3 and 5, the first and second bonding portions 40 may be disposed displaced in the circumferential direction from each other when viewed in the optical axis direction.

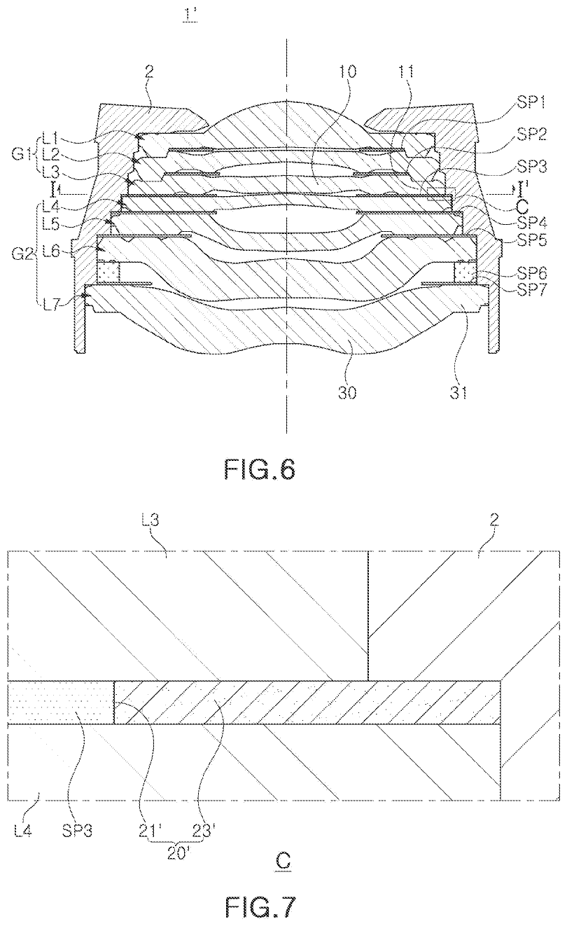

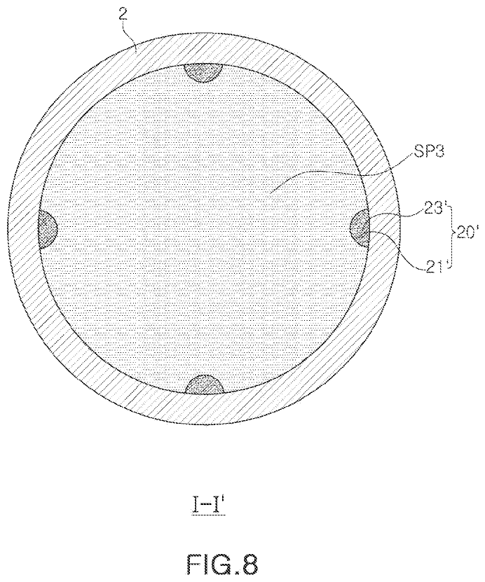

FIG. 6 is a schematic cross-sectional view of one or more examples of a lens assembly according to another embodiment, and FIG. 7 is an enlarged view of portion “C” of FIG. 6. FIG. 8 is a planar cross-sectional view taken along line I-I′ of FIG. 6.

A lens assembly 1′ according to the present embodiment is different from the lens assembly 1 according to the previously described embodiment in terms of the first bonding portion 20′. Further descriptions of the other elements may be omitted.

In an example of the present embodiment, a plurality of the lenses of the first lens group G1 are interconnected so that positions thereof may be fixed relative to the lens barrel 2.

To prevent the positions of the lenses of the first lens group G1 from being distorted, the first bonding portion 20′ is provided between the third spacer SP3 and the lens barrel 2.

The first bonding portion 20′ includes a bonding groove 21′ provided in the third spacer SP3 and an adhesive 23′ provided in the bonding groove 21′.

A spacer, for example, the third spacer SP3, is provided between the third lens L3 and the fourth lens L4, for example, between the first lens group G1 and the second lens group G2, and the adhesive 23′ is provided in a space surrounded by the first lens group G1, the second lens group G2, the third spacer SP3 and the lens barrel 2.

That is, the first bonding groove 21′ is sealed by the third lens L3, the fourth lens L4, the third spacer SP3 and the lens barrel 2, such that the adhesive 23′ can be prevented from leaking to outside of the bonding groove 21′.

A plurality of the first bonding portions 20′ may be spaced apart in the circumferential direction of the lens barrel 2. As an example, as illustrated in FIG. 8, four first bonding portions 20′ may be provided, and the four first bonding portions 20′ may be spaced apart by 90°. Further, the first and second bonding portions 20′ and 40 may be disposed displaced in the circumferential direction from each other when viewed in the optical axis direction.

As set forth above, according to the examples of the embodiments of the present disclosure, the lens assembly can easily align optical axes of a plurality of lenses and prevent positions of the lenses from being distorted.

While specific examples have been shown and described above, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A lens assembly, comprising:
a plurality of lenses comprising a first lens group and a second lens group disposed on an optical axis; and
a lens barrel accommodating the first and second lens groups;
wherein the first and second lens groups are fixed to the lens barrel in different manners,
wherein the first lens group comprises a plurality of lenses aligned by uneven portions of ribs of the lenses in contact with each other, and
wherein a first bonding portion is disposed between the lens barrel and a lens of the first lens group disposed closest to the second lens group.

2. The lens assembly of claim 1, wherein the first bonding portion comprises:
a first bonding groove disposed in the lens barrel, the lens disposed closest to the second lens group, or the lens barrel and the lens disposed closest to the second lens group; and
an adhesive disposed in the first bonding groove.

3. The lens assembly of claim 2, wherein a spacer is disposed between the first and second lens groups, and
wherein the adhesive is disposed in a space surrounded by the spacer and the first bonding groove.

4. The lens assembly of claim 1, wherein a plurality of the first bonding portions are spaced apart along a circumferential direction of the lens barrel.

5. The lens assembly of claim 4, wherein the plurality of the first bonding portions are spaced apart by 90°.

6. The lens assembly of claim 1, wherein the second lens group comprises a plurality of lenses fitted into the lens barrel.

7. The lens assembly of claim 1, wherein a second bonding portion is disposed between the lens barrel and a lens, among a plurality of lenses disposed in the second lens group, disposed farthest from the first lens group.

8. The lens assembly of claim 7, wherein the second bonding portion comprises:
a second bonding groove disposed in the lens barrel, the lens disposed farthest from the first lens group, or the lens barrel and the lens disposed farthest from the first lens group; and
an adhesive disposed in the second bonding groove.

9. The lens assembly of claim 8, wherein the second bonding portion further comprises a third bonding groove extending toward an optical axis from the second bonding groove.

10. The lens assembly of claim 7, wherein a plurality of the second bonding portions are spaced apart along a circumferential direction of the lens barrel.

11. The lens assembly of claim 10, wherein a plurality of the first bonding portions are spaced apart in the circumferential direction of the lens barrel, and
wherein the first and second bonding portions are disposed to be displaced in the circumferential direction from each other when viewed in an optical axis direction.

12. A lens assembly, comprising:
a plurality of lenses comprising a first lens group and a second lens group disposed on an optical axis;
a spacer disposed between the first and second lens groups; and
a lens barrel accommodating the first and second lens groups;
wherein the first and second lens groups are fixed to the lens barrel in different manners, and
wherein a first bonding portion is disposed between the spacer and the lens barrel.

13. The lens assembly of claim 12, wherein the first bonding portion comprises a bonding groove disposed in the spacer and an adhesive disposed in the bonding groove.

14. The lens assembly of claim 13, wherein the adhesive is disposed in a space surrounded by the first lens group, the second lens group, the spacer, and the lens barrel.

15. The lens assembly of claim 12, wherein a second bonding portion is disposed between the lens barrel and a lens, among a plurality of lenses of the second lens group, disposed farthest from the first lens group.

16. The lens assembly of claim 12, wherein a plurality of lenses of the first lens group are aligned with an uneven portion of a rib of each lens in contact with each other, and
wherein a plurality of lenses of the second lens group are fitted into the lens barrel.

17. A lens assembly, comprising:
a first lens disposed in a lens barrel on an optical axis;
a first bonding portion disposed to fix the first lens to the lens barrel and comprising:
a bonding groove in one or more of the lens and the lens barrel, and
an adhesive disposed in the groove,
wherein the adhesive is sealed in the bonding groove; and
a second lens disposed in the lens barrel on the optical axis and on the first lens, and fixed to the lens barrel in a different manner than the first lens.

18. The lens assembly of claim 17, further comprising one or more lenses disposed on the optical axis and the first lens, and opposite the second lens, between the first lens and the second lens, or opposite the second lens and between the first lens and the second lens.

19. The lens assembly of claim 18, wherein the one or more lenses are disposed opposite the second lens and between the first lens and the second lens,
wherein the first lens and the one or more lenses disposed opposite the second lens are aligned with an uneven portion of a rib of each lens in contact with an adjacent lens, and
wherein the second lens and the one or more lenses disposed between the first lens and the second lens are fitted into the lens barrel.

20. The lens assembly of claim 17, further comprising a spacer disposed between the first lens and the second lens, wherein the adhesive is sealed in the bonding groove by the spacer.
